(19) United States
(12) Patent Application Publication
(10) Pub. No.: US 2011/0032501 A1
(43) Pub. Date: Feb. 10, 2011

(54) EXPOSURE APPARATUS, EXPOSURE SYSTEM, AND METHOD OF MANUFACTURING SEMICONDUCTOR DEVICE

(76) Inventors: Kazuya FUKUHARA, Tokyo (JP); Masayuki HATANO, Kawasaki-Shi (JP); Takuya KONO, Yokosuka-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/830,881

(22) Filed: Jul. 6, 2010

(30) Foreign Application Priority Data
Aug. 7, 2009 (JP) 2009-184369

(51) Int. Cl. G03B 27/54

(52) U.S. Cl. 355/67

(57) ABSTRACT

In one embodiment, an exposure apparatus is configured to irradiate a mask with illumination light and to irradiate a wafer with light from the mask irradiated with the illumination light. The apparatus includes an information acquisition unit configured to acquire use history information that is information regarding a use history of the mask. The apparatus further includes a condition derivation unit configured to derive a setting value or a change amount of an optical setting condition of the exposure apparatus, based on the acquired use history information and correspondence information that indicates a correspondence between the use history of the mask and the optical setting condition of the exposure apparatus. The apparatus further includes an exposure unit configured to set the optical setting condition of the exposure apparatus to an optical setting condition specified by the derived setting value or change amount, and to expose the wafer under the set optical setting condition.

### CROSS REFERENCE TO RELATED APPLICATION

This application is based upon and claims the benefit of priority from the prior Japanese Patent Application No. 2009-184369, filed on Aug. 7, 2009, the entire contents of which are incorporated herein by reference.

### FIELD

Embodiments described herein relate to an exposure apparatus, an exposure system, and a method of manufacturing a semiconductor device, for example, for an exposure using an optical lithography technique.

### BACKGROUND

A photomask to be used in exposure has a life. In particular, if the number of times of exposure processing increases, it becomes impossible to use the photomask because of a degradation of its image performance. The degradation of the image performance is brought about by, for example, a change of optical constants of the photomask. If the optical constants of the photomask change, the performance (such as contrast) of an image projected onto a wafer at the time of exposure is degraded, and the precision of a resist dimension is aggravated.

If the mask life of the photomask is short, the mask cost required when manufacturing a semiconductor device increases, and the profit margin of the semiconductor device is lowered. Therefore, it becomes necessary to prolong the mask life as far as possible.

In a known technique, information to be used to control the operation of an exposure apparatus is recorded in an IC chip attached to an exposure member (mask). A manufacture history and the like of the mask are recorded in the IC chip. Further, the number of times that the mask has been used is recorded in the IC chip, for example. The number of times that the mask has been used is utilized to determine a timing of mask cleaning (see JP-A 2005-316021 (KOKAI)).

### BRIEF DESCRIPTION OF THE DRAWINGS

FIG. 1 is a diagram showing a configuration of an exposure system of a first embodiment;

FIG. 2 is a diagram schematically showing a configuration of an exposure apparatus shown in FIG. 1;

FIG. 3 is a block diagram showing configurations of an exposure apparatus and the exposure server shown in FIG. 1;

FIG. 4 shows sectional views for explaining a degradation of a mask;

FIG. 5 shows sectional views for explaining a degradation of an optical performance of the mask;

FIG. 6 is a top view showing a shape of an illumination unit included in an illumination optical system shown in FIG. 2;

FIG. 7 shows top views for explaining a change of an optical setting condition of the illumination unit;

FIG. 8 is a top view for explaining the shape of the illumination unit;

FIG. 9 is a top view for explaining the shape of the illumination unit;

FIG. 10 is a graph showing a change of thickness of an oxide film caused by the change of a light irradiation amount;

FIG. 11 is a graph showing a correspondence between the light irradiation amount and a luminance setting value at poles P_{Y};

FIG. 12 shows graphs showing a variation of an exposure margin caused by a change of the number of times of exposure processing;

FIG. 13 is a flowchart for explaining a method of manufacturing a semiconductor device of the first embodiment;

FIG. 14 is a flowchart for explaining the method of manufacturing the semiconductor device of the first embodiment;

FIG. 15 is a diagram schematically showing a configuration of an exposure apparatus of a second embodiment;

FIG. 16 is a sectional view showing a structure of a mask shown in FIG. 15;

FIG. 17 is a block diagram showing configurations of an exposure apparatus and an exposure server of a third embodiment;

FIG. 18 is a block diagram showing a configuration of an exposure apparatus of a fourth embodiment; and

FIG. 19 is a top view showing an example of a resist pattern formed on a wafer.

### DETAILED DESCRIPTION

Embodiments will now be explained with reference to the accompanying drawings.

An embodiment described herein is, for example, an exposure apparatus configured to irradiate a mask with illumination light and to irradiate a wafer with light from the mask irradiated with the illumination light. The apparatus includes an information acquisition unit configured to acquire use history information that is information regarding a use history of the mask. The apparatus further includes a condition derivation unit configured to derive a setting value or a change amount of an optical setting condition of the exposure apparatus, based on the acquired use history information and correspondence information that indicates a correspondence between the use history of the mask and the optical setting condition of the exposure apparatus. The apparatus further includes an exposure unit configured to set the optical setting condition of the exposure apparatus to an optical setting condition specified by the derived setting value or change amount, and to expose the wafer under the set optical setting condition.

Another embodiment described herein is, for example, an exposure system including an exposure apparatus configured to irradiate a mask with illumination light and to irradiate a wafer with light from the mask irradiated with the illumination light, and an exposure server configured to function as a server for the exposure apparatus. The apparatus includes an information acquisition unit configured to acquire use history information that is information regarding a use history of the mask. The apparatus further includes a condition derivation unit configured to derive a setting value or a change amount of an optical setting condition of the exposure apparatus, based on the acquired use history information and correspondence information that indicates a correspondence between the use history of the mask and the optical setting condition of the exposure apparatus and is stored in the exposure server. The apparatus further includes an exposure unit configured to set the optical setting condition of the exposure apparatus to an optical setting condition specified by the derived setting value or change amount, and to expose the wafer under the set optical setting condition.

Another embodiment described herein is, for example, a method of manufacturing a semiconductor device by using an exposure apparatus configured to irradiate a mask with illumination light and to irradiate a wafer with light from the mask irradiated with the illumination light. The method includes acquiring use history information that is information regarding a use history of the mask. The method further includes deriving a setting value or a change amount of an optical setting condition of the exposure apparatus, based on the acquired use history information and correspondence information that indicates a correspondence between the use history of the mask and the optical setting condition of the exposure apparatus. The method further includes setting the optical setting condition of the exposure apparatus to an optical setting condition specified by the derived setting value or change amount, and exposing the wafer under the set optical setting condition.

### First Embodiment

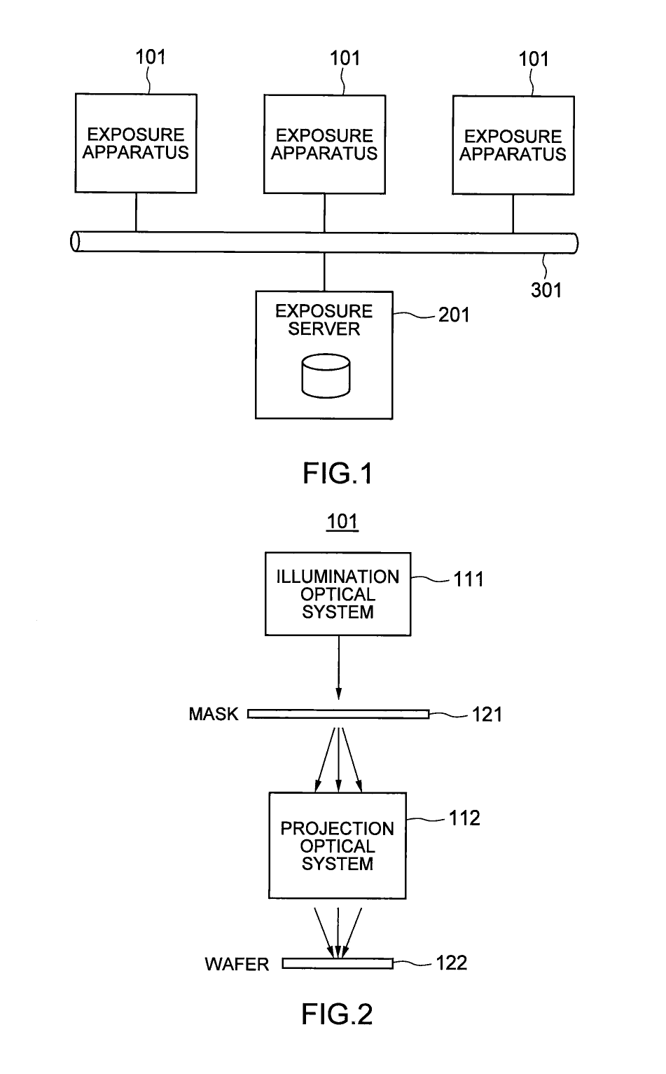

FIG. 1 is a diagram showing a configuration of an exposure system of a first embodiment.

The exposure system shown in FIG. 1 includes a plurality of exposure apparatuses 101, and an exposure server 201 configured to function as a server for these exposure apparatuses 101. The exposure apparatus 101 is, for example, an ArF (argon fluoride) exposure apparatus. The exposure server 201 is, for example, an information processing apparatus such as a personal computer or a work station. The exposure apparatuses 101 and the exposure server 201 are connected to each other via a network 301 such as a LAN (Local Area Network).

The number of the exposure apparatuses 101 and the exposure servers 201 included in the exposure system shown in FIG. 1 is arbitrary. Hereafter, configurations of each of the exposure apparatuses 101 and the exposure server 201 shown in FIG. 1 will be described.

FIG. 2 is a diagram schematically showing a configuration of an exposure apparatus 101 shown in FIG. 1.

As shown in FIG. 2, the exposure apparatus 101 includes an illumination optical system 111 and a projection optical system 112. The illumination optical system 111 is an optical system configured to irradiate a photomask 121 with illumination light. The projection optical system 112 is an optical system configured to irradiate a wafer 122 with exposure light obtained from the illumination light with which the photomask 121 is irradiated. The exposure apparatus 101 irradiates the photomask 121 with the illumination light by using the illumination optical system 111 and the projection optical system 112, and irradiates the wafer 122 with the light from the photomask 121 irradiated with the illumination light. The photomask 121 is a transparent type mask in the present embodiment. However, the photomask 121 may be a reflection type mask.

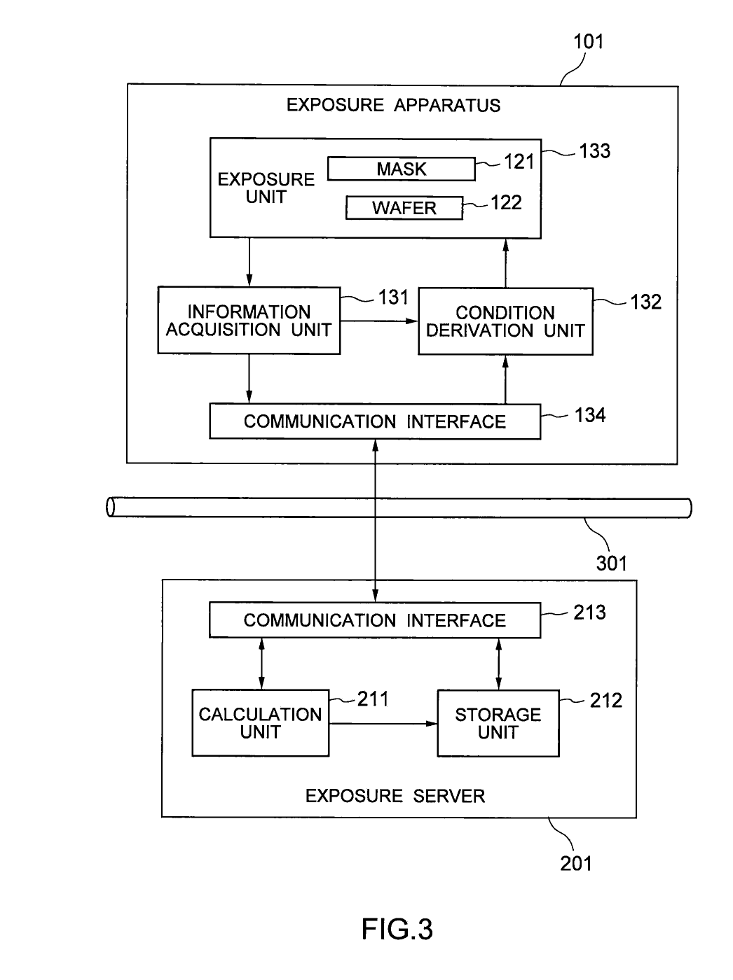

FIG. 3 is a block diagram showing configurations of an exposure apparatus 101 and the exposure server 201 shown in FIG. 1.

In the exposure system in the present embodiment, an optical setting condition of the exposure apparatus 101 is adjusted according to a use history of the mask 121 in order to maintain the image performance for a long term and prolong the life of the mask 121. FIG. 3 shows various blocks concerned in execution of such processing.

As shown in FIG. 3, the exposure apparatus 101 includes an information acquisition unit 131, a condition derivation unit 132, an exposure unit 133, and a communication interface 134. The exposure server 201 includes a calculation unit 211, a storage unit 212, and a communication interface 213.

The exposure unit 133 includes the illumination optical system 111 and the projection optical system 112 shown in FIG. 2. As shown in FIG. 2, the exposure unit 133 exposes the wafer 122 by using the mask 121. The mask 121 and the wafer 122 are shown in FIG. 3 as well.

Correspondence information that indicates a correspondence between the use history of the mask 121 and the optical setting condition of the exposure apparatus 101 is stored in the storage unit 212. The correspondence information is, for example, such information that indicate an instruction “when the use history of the mask 121 is set to X, the optical setting condition of the exposure apparatus 101 is set to Y.”

In the present embodiment, the correspondence information indicates an optical setting condition which keeps a contrast of an obtained image constant even if the use history of the mask 121 changes. Therefore, for example, when the use history of the mask 121 has changed from X to X′, the optical setting condition of the exposure apparatus 101 is changed from Y to Y′ based on the correspondence information in the present embodiment, so that the contrast of the obtained image can be kept constant. In the present embodiment, therefore, it is possible to maintain the image performance for a long term and prolong the life of the mask 121.

In the present embodiment, the correspondence information is prepared for respective masks 121, for example, correspondence information for a gate processing mask, correspondence information for a contact processing mask, correspondence information for an interconnect processing mask, and the like.

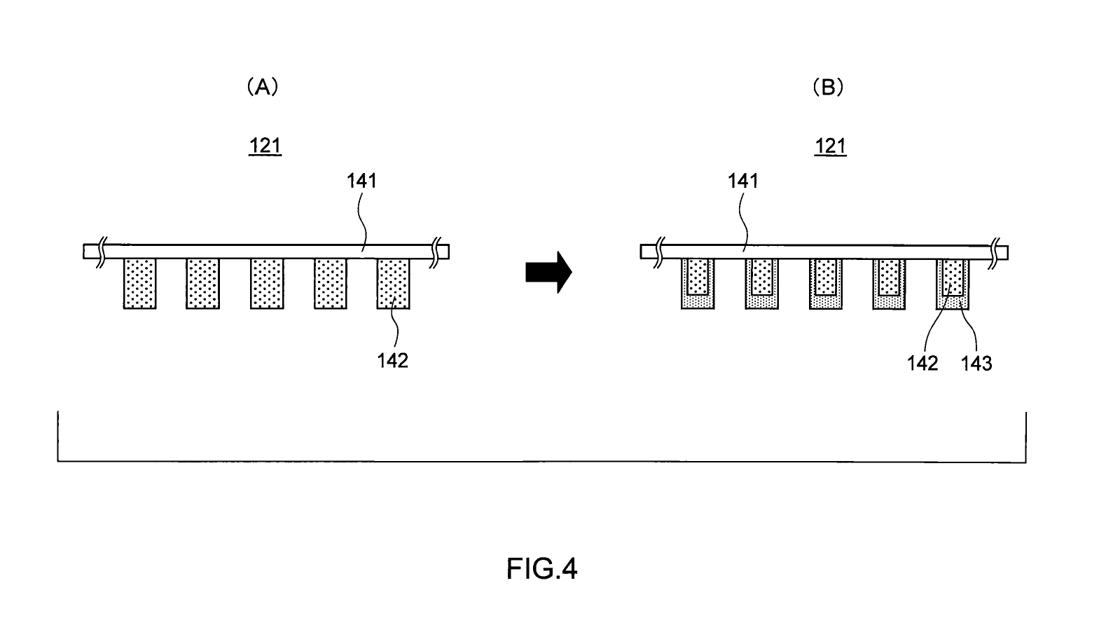

The correspondence information for each mask 121 is collected by actually conducting the exposure processing by using another mask having the same structure as the mask 121. The another mask having the same structure as the mask 121 includes a shading film whose material and pattern layout are same as those of the shading film 142 of the mask 121 (refer to FIG. 4). When conducting the exposure processing by using the correspondence information for the mask 121, the correspondence information for the mask 121 is previously collected, and the collected correspondence information is previously stored in the storage unit 212.

The exposure apparatus 101 to be used to collect the correspondence information and the exposure apparatus 101 which conducts the exposure processing by using the collected correspondence information may be the same exposure apparatus or may be different exposure apparatuses. The system configuration shown in FIG. 1 has an advantage that the correspondence information collected by one exposure apparatus 101 can be shared by a plurality of exposure apparatuses 101. Therefore, it is desirable to form the exposure system shown in FIG. 1 of the exposure apparatuses 101 of the same kind or the exposure apparatuses 101 capable of sharing the optical setting condition.

The information acquisition unit 131 and the condition derivation unit 132 are blocks for changing the optical setting condition of the exposure apparatus 101 according to a change of the use history of the mask 121.

The information acquisition unit 131 is configured to acquire use history information that is information regarding the use history of the mask 121. The use history information acquired by the information acquisition unit 131 is given to the condition derivation unit 132.

Examples of the use history information include a light irradiation amount to the mask 121, the number of wafers processed by using the mask 121, and light irradiation time to the mask 121. For example, the light irradiation amount to the mask 121 represents the total amount of light with which the mask 121 is irradiated since the start of using the mask 121, and its value is represented by the exposure amount unit mJ/cm². The light irradiation amount can be calculated by multiplying an illuminance measured with an illuminance meter provided in the exposure unit 133, by exposure time.

The condition derivation unit 132 is configured to derive a setting value or a change value of the optical setting condition for changing the optical setting condition of the exposure apparatus 101, based on the use history information given by the information acquisition unit 131 and the correspondence information read from the storage unit 212. The correspondence information is read from the storage unit 212 via the communication interfaces 134 and 213 and the network 301. Further, the setting value or the change value calculated by the condition derivation unit 132 is given to the exposure unit 133.

Examples of the optical setting condition includes a luminance distribution, a wavelength distribution, a shape (σ), and a polarization state of the illumination light, a numerical aperture (NA) and an aberration of a projection lens for irradiating the wafer 122 with the exposure light, and an inclination amount of the principal surface of the wafer 122 to the image forming plane. In the present embodiment, the contrast and depth of focus of the image projected onto the wafer 122 can be changed by changing at least one of these optical setting conditions.

When changing the optical setting condition regarding the exposure processing using a certain mask 121, the condition derivation unit 132 calculates the setting value or the change value of the optical setting condition, based on the use history information and the correspondence information regarding the certain mask 121. For example, if the use history information indicates that the light irradiation amount to the mask 121 is X and the correspondence information indicates that the value X of the light irradiation amount to the mask 121 corresponds to the setting value Y of the numerical aperture NA, then the condition derivation unit 132 derives Y as the setting value of the numerical aperture NA.

The correspondence information may indicate that the value X of the light irradiation amount corresponds to the change amount ΔY of the numerical aperture from its initial setting value, where change amount ΔY=setting value Y−initial setting value Y₀. In this case, the condition derivation unit 132 derives ΔY as the change amount of the numerical aperture from its initial setting value.

The exposure unit 133 changes the optical setting condition of the exposure apparatus 101 to an optical setting condition specified by the setting value or the change amount which is given by the condition derivation unit 132, and exposes the wafer 122 by using the mask 121 under the changed optical setting condition. For example, if the setting value Y or the change amount ΔY (=Y−Y₀) is given, the numerical aperture NA is changed to Y.

In this way, the contrast of the obtained image can be kept constant in the present embodiment, even if the use history of the mask 121 changes. As a result, it is possible in the present embodiment to maintain the image performance for a long term and prolong the life of the mask 121.

In the present embodiment, the correspondence information is collected by acquiring the use history information by the information acquisition unit 131, giving the use history information to the calculation unit 211, calculating the setting value or the change value of the optical setting condition by the calculation unit 212 for an adjustment of the optical setting condition of the exposure apparatus 101, and associating the use history indicated by the given use history information with the calculated optical setting condition by the calculation unit 211. Giving the use history information to the calculation unit 211 by the information acquisition unit 131 is conducted via the communication interfaces 134 and 213 and the network 301. The calculation unit 211 generates the correspondence information that indicates the correspondence between the use history and the optical setting condition, and stores the generated correspondence information in the storage unit 212. Details of these kinds of processing will be described below.

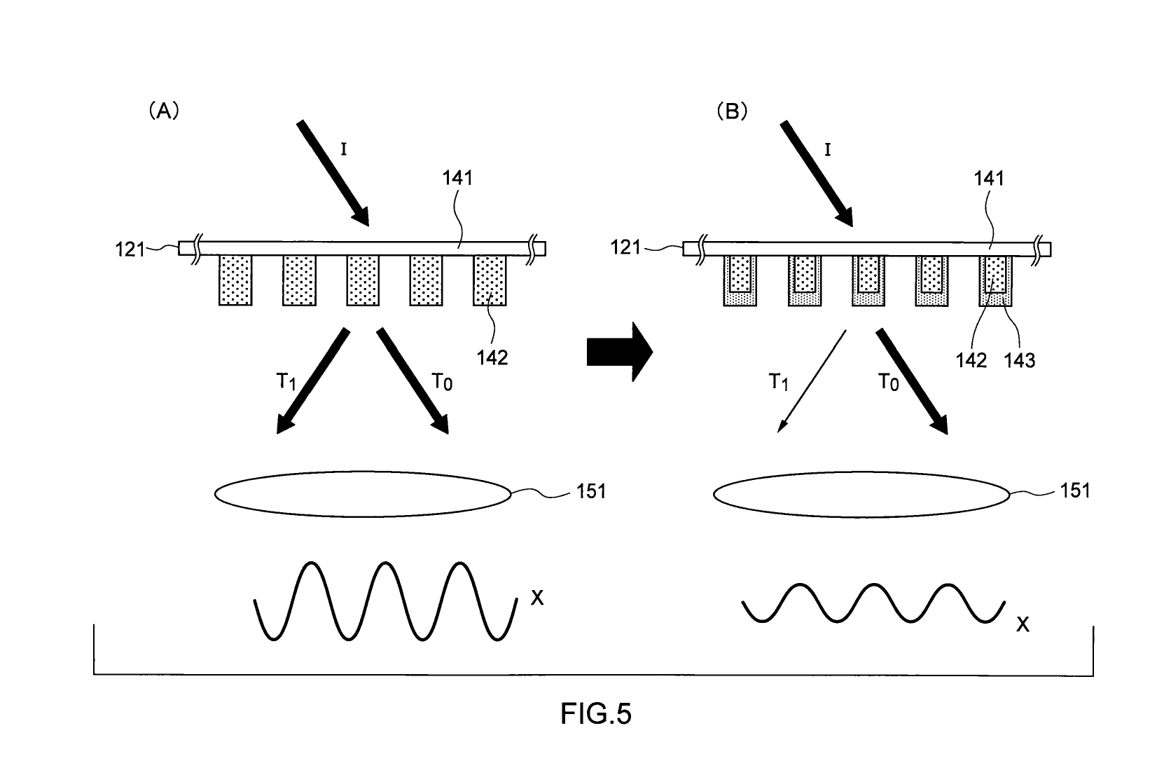

Hereafter, a degradation of the mask 121 will be described with reference to FIGS. 4 and 5.

FIG. 4 shows sectional views for explaining the degradation of the mask 121.

As shown in FIG. 4(A), the mask 121 includes, for example, a mask substrate 141, and a shading film 142 formed on the mask substrate 141. The shading film 142 is, for example, a MoSi (molybdenum silicide) film.

As a result of a study conducted by the present inventors, it has been found that the surface of the shading film 142 of the mask 121 is oxidized gradually as the light irradiation amount increases. FIG. 4(B) shows an oxide film 143 generated by oxidation of the surface of the shading film 142.

Furthermore, according to the study conducted by the present inventors, it is found that the oxidation of the surface of the shading film 142 is one of primary factors which determine the life of the mask 121. This will now be described with reference to FIG. 5. FIG. 5 shows sectional views for explaining a degradation of an optical performance of the mask 121.

FIG. 5(A) shows the mask 121 before the oxidation occurs. If the mask 121 is irradiated with illumination light I, exposure light including 0th order diffracted light Tₒ and first order diffracted light T₁ is obtained. The top of the wafer 122 (see FIG. 2 or the like) is irradiated with the exposure light via a lens 151. In FIG. 5(A), the contrast of an image projected onto the wafer 122 is represented schematically by a waveform denoted by X.

On the other hand, FIG. 5(B) shows the mask 121 after the oxidation has occurred. The oxidation of the surface of the shading film 142 brings about changes of optical constants of the mask 121. The changes of the optical constants of the mask 121 bring about a change of the exposure light obtained from the illumination light I with which the mask 121 has been irradiated. FIG. 5(B) shows a state in which the intensity of the first order diffracted light T₁ included in the exposure light is lowered.

Such a change of the exposure light changes the performance of the image projected onto the wafer 122. In general, the change of the image performance is degradation. This degradation of the image performance aggravates the precision of a resist dimension. FIG. 5(B) shows a state in which the contrast of the image projected onto the wafer 122 is degraded as compared with FIG. 5(A).

The above described change of the exposure light brings about a dimension deviation (coarse-dense dimension difference) between a crowd pattern and an isolated pattern in a resist pattern, besides the change of the contrast of the obtained image. The crowd pattern corresponds to, for example, a periodic pattern such as an L/S (Line and Space) pattern. The isolated pattern corresponds to, for example, an aperiodic pattern located outside the L/S pattern.

According to the study conducted by the present inventors, it has been found that the life of the mask 121 depends on primary factors such as adhesion of ammonium sulfide due to a nitrogen compound or a sulfur oxide in the environment, and adhesion of a silicon oxide due to an organic silicon gas and active oxygen, besides the oxidation of the surface of the shading film 142. The adhesion of ammonium sulfide is contamination which can be recovered from by cleaning. On the other hand, the oxidation of the surface of the shading film 142 and the adhesion of the silicon oxide have a feature that they are contamination which cannot be recovered from by cleaning. The oxidation of the shading film of the mask is described in, for example, “4. Radiation Damage” in a paper “Thomas Faure et al., Proc. of SPIE Vol. 7122 712209, Photomask Technology 2008.”

As described above, the use of the mask 121 for a long term brings about the degradation of the contrast of the obtained image and the coarse-dense dimension difference in the resist pattern. The degradation of the contrast or the aggravation of the coarse-dense dimension difference brings about an aggravation of the yield of the semiconductor device due to generations of defects and pattern falling. Therefore, if the degradation amount of the contrast or the magnitude of the coarse-dense dimension difference exceeds a certain threshold, it becomes impossible to use the mask 121.

In the present embodiment, therefore, image characteristics are made unchanged from those before the degradation of the mask 121 by changing the optical setting condition of the exposure apparatus 101 to compensate the image change caused by the degradation of the mask 121. As a result, it is possible in the present embodiment to effectively prolong the life of the mask 121.

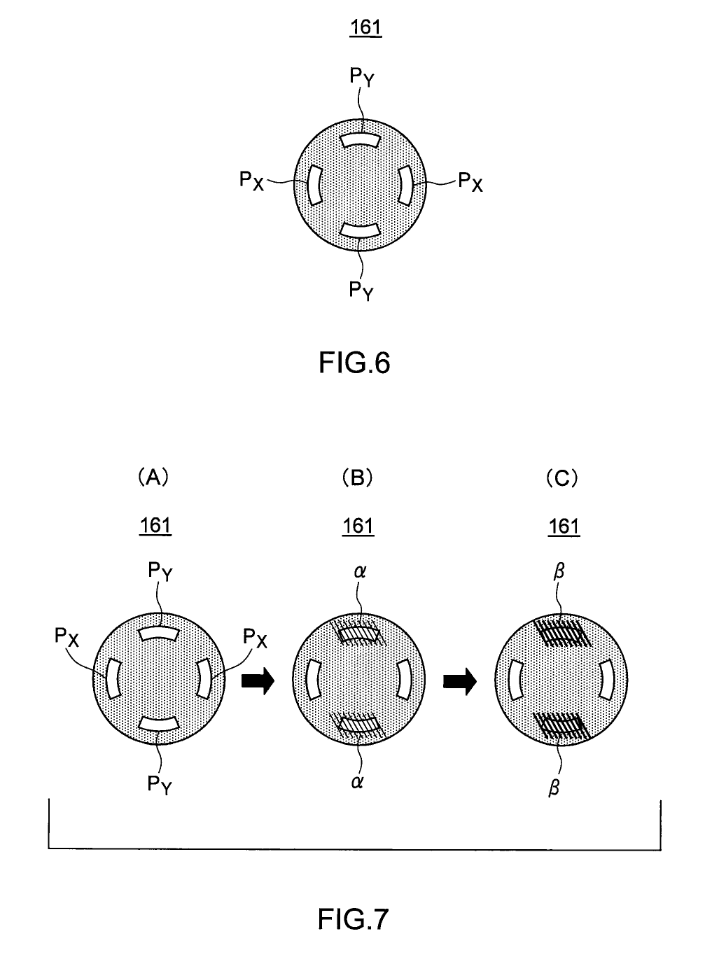

Hereafter, a specific example of a method for changing the optical setting condition of the exposure apparatus 101 will be described with reference to FIGS. 6 to 9.

FIG. 6 is a top view showing a shape of an illumination unit 161 included in the illumination optical system 111 shown in FIG. 2. As shown in FIG. 6, the illumination unit 161 has four poles. Illumination emitted from the illumination unit 161 becomes quadruple pole cross-pole illumination. In FIG. 6, two poles in the X direction are denoted by P_{X}, and two poles in the Y direction are denoted by P_{Y}. The X direction and the Y direction are examples of a first direction and a second direction which is different from the first direction, respectively.

FIG. 7 shows top views for explaining the change of the optical setting condition of the illumination unit 161. In the present embodiment, the optical setting condition of the exposure apparatus 101 can be changed by changing the optical setting condition of the illumination unit 161 as shown in FIGS. 7(A) to (C). FIGS. 7(A) to (C) show a state in which the optical setting condition of the illumination unit 161 is changed by changing an XY luminance balance of the illumination to compensate the degradation of the contrast of the obtained image. In FIG. 7, 9α indicates a state in which the luminance of the poles P_{Y} is lowered, and β indicates a state in which the luminance of the poles P_{Y} is further lowered.

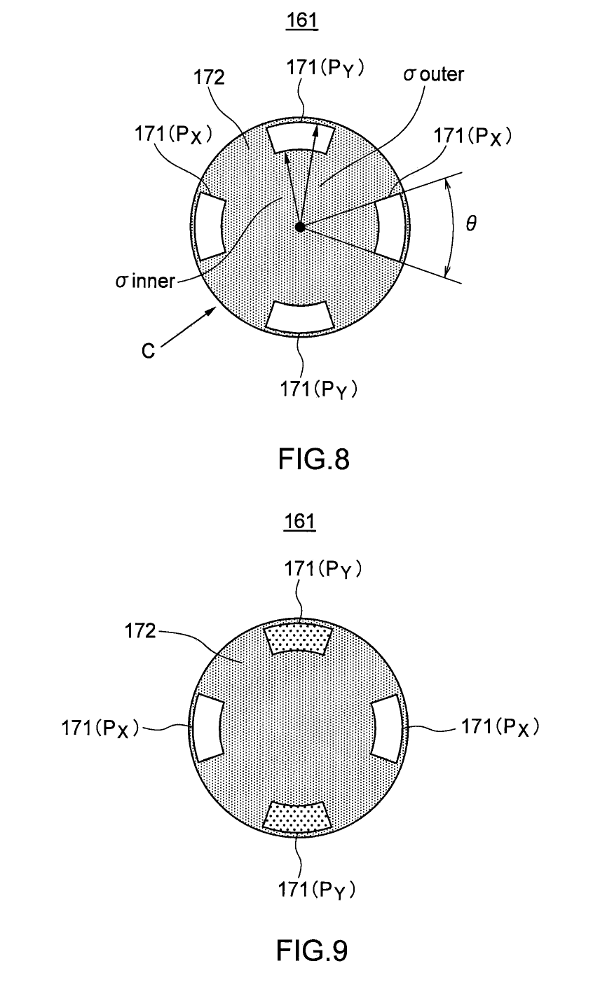

FIG. 8 is a top view for explaining the shape of the illumination unit 161. In FIG. 8, light emission areas of the illumination unit 161 are denoted by 171, and a non-light emission area is denoted by 172.

In FIG. 8, σᵢₙₙₑᵣ and σₒᵤₜₑᵣ are shown as σ values which are parameters regarding the shape of the illumination light. In FIG. 8, σᵢₙₙₑᵣ and σₒᵤₜₑᵣ are parameters proportional to an inside diameter and an outside diameter of the quadruple pole cross-pole illumination, respectively. FIG. 8 further shows an opening angle θ which is a parameter regarding the shape of the illumination light. In the present embodiment, the optical setting condition of the illumination unit 161 may be changed by changing at least one of σᵢₙₙₑᵣ, σₒᵤₜₑᵣ, and θ. The character C shown in FIG. 8 represents a circle having σ=1.

As examples of the optical setting condition of the exposure apparatus 101, the luminance distribution of the illumination light has been described with reference to FIG. 7, and the shape of the illumination light has been described with reference to FIG. 8. However, examples of the optical setting condition of the exposure apparatus 101 are not restricted to them. Another example of the optical setting condition of the exposure apparatus 101 includes the polarization state of the illumination light (such as S-polarized light and P-polarized light). Similarly to FIG. 7, FIG. 9 shows a state in which the optical setting condition of the exposure apparatus 101 is changed by changing the balance of the luminance distribution of the illumination light. FIG. 9 is a top view for explaining the shape of the illumination unit 161, similarly to FIG. 8.

In the case of FIG. 8, the optical setting condition of the exposure apparatus 101 can be represented as, for example, “NA=1.3, quadruple pole cross-pole illumination, σᵢₙₙₑᵣ=0.70, σ_{outer=0.95}, and tangential line polarized light illumination.” In the case where the optical setting condition is changed as shown in FIG. 9, the correspondence information can be represented, for example, as a function (or a table) that indicates the correspondence between the light irradiation amount and the luminance at the poles P_{Y}.

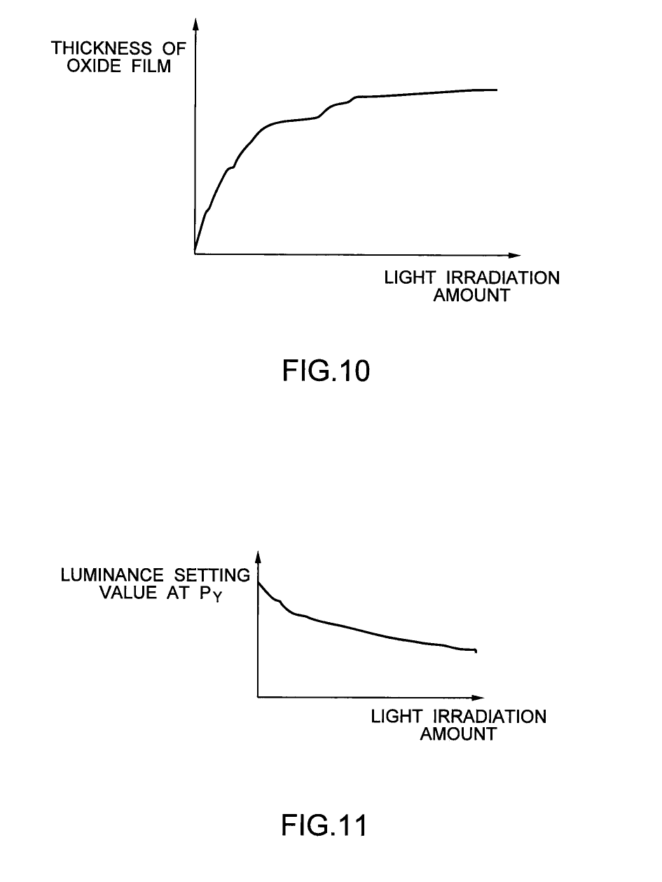

In the above, the degradation of the mask 121 has been described with reference to FIGS. 4 and 5, and the specific example of the method of changing the optical setting condition of the exposure apparatus 101 has been described with reference to FIGS. 6 to 9. Further details of these contents will now be described with reference to graphs shown in FIGS. 10 to 12.

FIG. 10 is a graph showing a change of thickness of the oxide film 143 caused by the change of the light irradiation amount.

As described above, according to the study conducted by the present inventors, the surface of the shading film 142 of the mask 121 is gradually oxidized as the light irradiation amount increases, and the oxide film 143 is generated on the surface of the shading film 142 (see FIG. 4). The graph in FIG. 10 shows that the thickness of the oxide film 143 increases as the light irradiation amount increases. According to the study conducted by the present inventors, the surface oxidation of the oxide film 142 becomes one of primary factors which determine the life of the mask 121. The speed of the surface oxidation of the shading film 142 depends on the use environment and the storage environment of the mask 121, and it is considered that masks 121 in respective exposure apparatus 101 have different speeds regarding the speed of the surface oxidation of the shading film 142.

FIG. 11 is a graph showing a correspondence between the light irradiation amount and the luminance setting value at the poles P_{Y}.

As described above, an example of the optical setting condition of the exposure apparatus 101 includes the luminance at the poles P_{Y} of the illumination unit 161 (see FIG. 7). In this case, the correspondence information that indicates the correspondence between the light irradiation amount and the luminance setting value at the poles P_{Y} is given, for example, as a graph shown in FIG. 11. FIG. 11 shows that the luminance setting value at the poles P_{Y} is lowered as the light irradiation amount increases. In the present embodiment, the degradation of the contrast of the obtained image can be compensated by lowering the luminance setting value at the poles P_{Y} as the light irradiation amount increases as shown in FIG. 11.

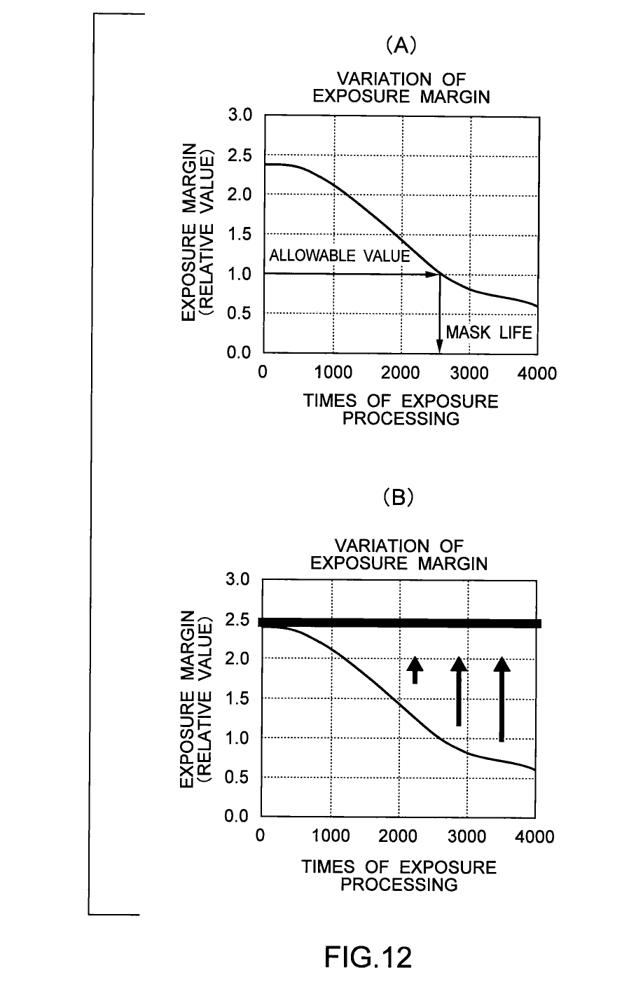

FIG. 12 shows graphs showing the variation of the exposure margin caused by a change of the number of times of the exposure processing.

In the case where the exposure processing is conducted by the conventional exposure system, the exposure margin gradually falls as the number of times of the exposure processing per mask increases as shown in FIG. 12(A). If the lower limit of the allowable value of the exposure margin is, for example, 1%, the number of times of the exposure processing of approximately 2500 becomes the life of each mask in FIG. 12(A).

On the other hand, in the case where the exposure processing is conducted by the exposure system in the present embodiment, the optical setting condition of the exposure apparatus 101 is adjusted according to the use history of the mask 121. In the present embodiment, therefore, the falling of the exposure margin caused by the increase of the number of times of the exposure processing can be compensated as shown in FIG. 12(B). As a result, the life of the mask 121 can be prolonged in the present embodiment.

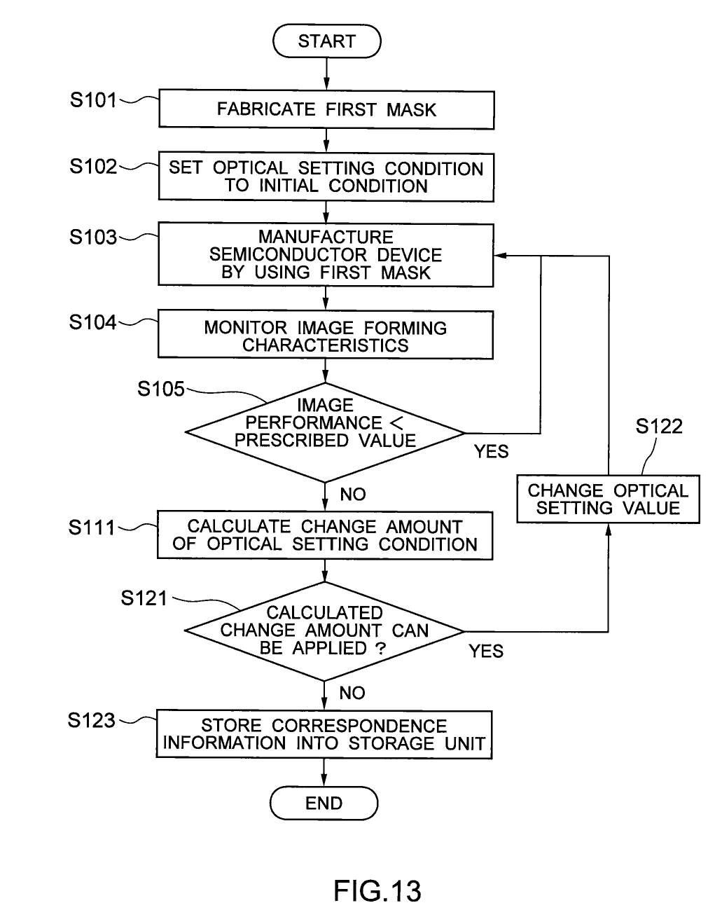

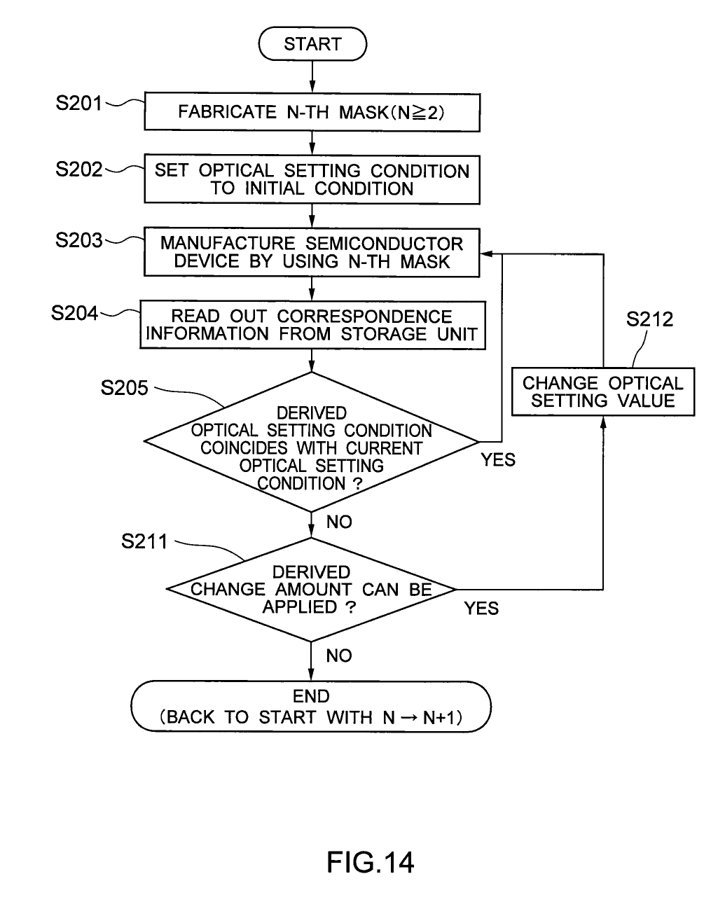

Hereafter, a method for manufacturing a semiconductor device by using the exposure system according to the present embodiment will be described with reference to FIGS. 13 and 14.

In the present embodiment, the correspondence information is prepared for respective masks 121, for example, correspondence information for the gate processing mask, correspondence information for the contact processing mask, correspondence information for the interconnect processing mask, and the like. The correspondence information for each mask 121 is collected by actually conducting the exposure processing by using another mask having the same structure as the mask 121. Hereafter, the exposure processing for collecting the correspondence information will be described with reference to FIG. 13, and exposure processing conducted by using the collected correspondence information will be described with reference to FIG. 14. As for reference characters which appear in the ensuing description, see FIGS. 1 to 3.

FIG. 13 is a flowchart for explaining a method of manufacturing a semiconductor device of the present embodiment. In FIG. 13, the exposure processing for collecting the correspondence information is conducted.

In the flow shown in FIG. 13, a first mask 121 to be used to collect the correspondence information is first fabricated (step S101).

Then, the optical setting condition of the exposure apparatus 101 is set to an initial condition (step S102). The setting value of the initial condition corresponds to the above described initial setting value Y₀.

Then, semiconductor devices are manufactured repeatedly by using the exposure apparatus 101 and the first mask 121 (step S103). During this time, image forming characteristics of the mask 121 are monitored (for example, periodically) in the exposure apparatus (step S104), and a determination is made whether the image performance is within a prescribed value (step S105).

If the image performance exceeds the prescribed value, the calculation unit 211 calculates the change amount of the optical setting condition of the exposure apparatus 101 to compensate the degradation of the image performance (step S111). At this time, the use history information at the current time point of the mask 121 is given to the calculation unit 211 by the information acquisition unit 131. In the exposure server 201, the calculated change amount is associated with the use history indicated by the given use history information and managed.

If the calculated change amount can be applied to the exposure apparatus 101 (step S121), the exposure unit 133 changes the optical setting condition of the exposure apparatus 101 to an optical setting condition specified by the calculated change amount (step S122). In the exposure apparatus 101, manufacture of the semiconductor devices is continued under the changed optical setting condition (steps S103 to S105).

On the other hand, if the calculated change amount is not applicable to the exposure apparatus 101 (step S121), the mask 121 is deemed to have exceeded its life and discarded. Furthermore, information indicating the correspondence between the use history of the mask 121 and the optical setting condition of the exposure apparatus 101, which is collected through the manufacture of the semiconductor devices, is stored into the storage unit 212 as the correspondence information by the calculation unit 211 (step S123).

FIG. 14 is a flowchart for explaining the method of manufacturing the semiconductor device of the present embodiment. In FIG. 14, the exposure processing using the collected correspondence information is conducted.

In the flow shown in FIG. 14, the second or subsequent mask 121 which has the same structure as the first mask 121 is first fabricated (step S201). In FIG. 14, each of the second and subsequent masks 121 is denoted by N-th mask 121 (where N is an integer of at least 2).

Then, the optical setting condition of the exposure apparatus 101 is set to its initial condition (step S202). The setting value of the initial condition corresponds to the above described initial setting value Y₀.

Then, semiconductor devices are manufactured repeatedly by using the exposure apparatus 101 and the N-th mask 121 (step S203). During this time, the condition derivation unit 132 refers to the storage unit 212 (for example, periodically), and reads out the correspondence information corresponding to the use history of the mask 121 at the current time point from the storage unit 212 (step S204). The condition derivation unit 132 recognizes the use history of the mask 121 at the current time point, based on use history information provided from the information acquisition unit 131. Then, the condition derivation unit 132 derives the change amount of the optical setting condition corresponding to the use history of the mask 121 at the current time point, based on the correspondence information which is read out, and makes a determination whether the derived optical setting condition (change amount) coincides with the optical setting condition (change amount) of the exposure apparatus 101 at the current time point (step S205).

If the derived optical setting condition does not coincide with the optical setting condition of the exposure apparatus 101 at the current time point, the condition derivation unit 132 makes a determination whether the derived change amount can be applied to the exposure apparatus 101 (step S211).

If the derived change amount can be applied to the exposure apparatus 101 (step S211), the exposure unit 133 changes the optical setting condition of the exposure apparatus 101 to an optical setting condition specified by the derived changed amount (step S212). In the exposure apparatus 101, manufacture of the semiconductor devices is continued under the changed optical setting condition (steps S203 to S205).

On the other hand, if the derived change amount is not applicable to the exposure apparatus 101 (step S211), the mask 121 is deemed to have exceeded its life and discarded.

In this way, in the present embodiment, the semiconductor devices can be manufactured according to the flows shown in FIGS. 13 and 14. According to the flow shown in FIG. 13, the life of the first mask 121 can be prolonged. According to the flow shown in FIG. 14, lives of the second and subsequent masks 121 can be prolonged. Especially in the flow shown in FIG. 14, the optical setting condition is adjusted by using the correspondence information obtained in the flow shown in FIG. 13, and consequently the adjustment of the optical setting condition can be conducted with a lighter load and in a shorter time.

As described above, in the present embodiment, the setting value or the change amount of the optical setting condition is derived based on the use history information that is information regarding the use history of the mask 121, and the correspondence information that indicates the correspondence between the use history of the mask 121 and the optical setting condition of the exposure apparatus 101, and the exposure processing by using the mask 121 is conducted under the optical setting condition which is set according to the setting value or the change amount. In the present embodiment, consequently, it becomes possible to adjust the optical setting condition of the exposure apparatus 101 according to the use history of the mask 121 and prolong the life of the mask 121.

According to the present embodiment, it becomes possible to continue to use the mask 121 even if the number of times of using the mask 121 increases and the optical performance of the mask 121 changes. Accordingly, the life of the mask 121 is effectively prolonged. As a result, the manufacture cost of the semiconductor device can be reduced.

Hereafter, second to fourth embodiments will be described. Since these embodiments are modifications of the first embodiment, these embodiments will be described laying stress on differences from the first embodiment.

### Second Embodiment

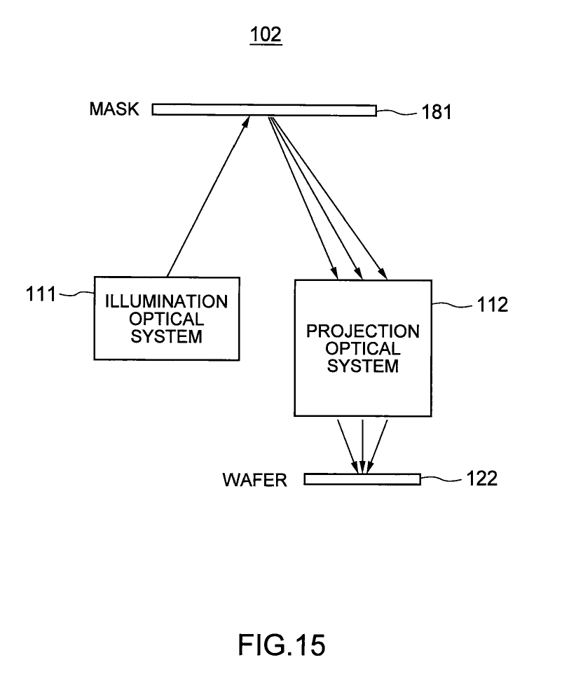

FIG. 15 is a diagram schematically showing a configuration of an exposure apparatus 102 of a second embodiment.

Whereas the exposure apparatus 101 shown in FIG. 2 is an ArF exposure apparatus, the exposure apparatus 102 shown in FIG. 15 is an EUV (Extreme Ultra Violet) exposure apparatus. Therefore, a mask 181 shown in FIG. 15 is a reflection type mask.

Each of the exposure apparatus 101 shown in FIG. 2 and the exposure apparatus 102 shown in FIG. 15 commonly has the configuration of the exposure apparatus 101 shown in FIG. 3. In the present embodiment, therefore, the life of the mask 181 can be prolonged by adjusting the optical setting condition of the exposure apparatus 102 according to the use history of the mask 181.

In general, the mask of reflection type is more expensive than the mask of transmission type. Therefore, it can be said that the effect of the prolongation of the mask life is great especially in the present embodiment. According to the present embodiment, therefore, it becomes possible to remarkably reduce the manufacture cost of the semiconductor device which is manufactured by using the mask of reflection type.

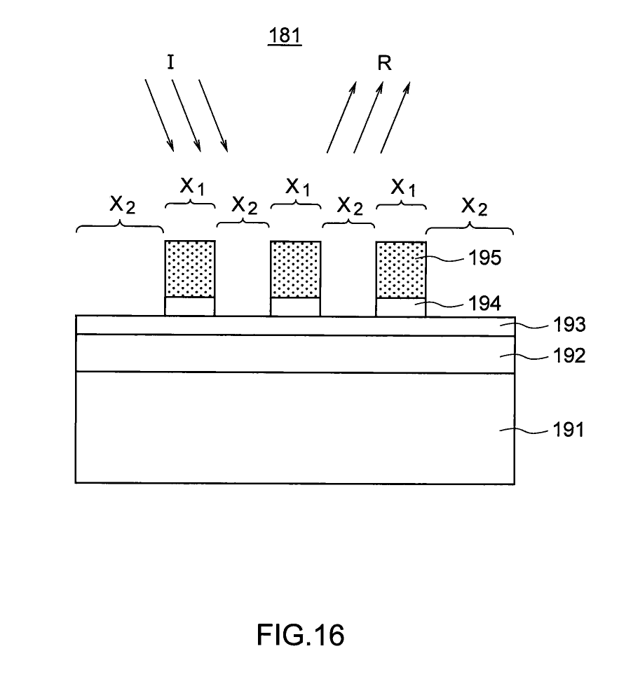

According to the study conducted by the present inventors, regarding the mask for EUV, changes of the optical constants and the shape of an absorption layer included in the mask pose a problem. This is nearly the same as the problem posed in the mask 121 in the first embodiment although there is the difference of the shading film from the absorption layer. Therefore, the exposure processing in the second embodiment is effective to the mask for EUV as well. Details of the mask for EUV will be described with reference to FIG. 16.

FIG. 16 is a sectional view showing a structure of the mask 181 shown in FIG. 15.

As shown in FIG. 16, the mask 181 includes a substrate 191, and a multilayer film 192, a cap layer 193, a buffer layer 194, and an absorption layer 195 which are formed on the substrate 191 in order. Note that the vertical direction in FIG. 16 is inverted from the vertical direction in FIG. 15.

The multilayer film 192 is a layer having a higher reflectivity than the substrate 191. The multilayer film 192 is, for example, a film in which Mo (molybdenum) layers and Si (silicon) layers are alternately stacked. The cap layer 193 is a protective film for protecting the surface of the multilayer film 192. The cap layer 193 is, for example, a Si layer, an Ru (ruthenium) layer, or an TiO (titanium oxide) layer.

The buffer layer 194 is an etching stopper used when the absorption layer 195 is etched. The buffer layer 194 is, for example, a Cr (chromium) layer, or a Cr compound layer such as a CrN (chromium nitride) layer. The absorption layer 195 is a layer capable of absorbing light. The absorption layer 195 is, for example, a Ta (tantalum) compound layer such as a TaN (tantalum nitride) layer, a TaBN (tantalum boride nitride) layer, or a TaBO (tantalum boride oxide) layer.

FIG. 16 shows incident light I onto the mask 181, and reflected light R from the mask 181. The reflected light R is obtained due to the reflection of the incident light I in reflection areas X₁ on the mask 181 and the absorption of the incident light I in absorption areas X₂ on the mask 181. In the absorption areas X₂, the substrate 191 is covered with the absorption layer 195. In the reflection areas X₁, the cap layer 193 is exposed by removing the absorption layer 195.

The correspondence information for each mask 181 is collected by actually conducting the exposure processing by using another mask having the same structure as the mask 181. The another mask having the same structure as the mask 181 includes an absorption layer whose material and pattern layout are same as those of the absorption layer 195 of the mask 181. When conducting the exposure processing by using the correspondence information for the mask 181, the correspondence information for the mask 181 is previously collected, and the collected correspondence information is previously stored in the storage unit 212 (refer to FIG. 3).

As described above, according to the present embodiment, it becomes possible to prolong the life of the reflection type mask which is great in effect of a life prolongation. The exposure apparatus 102 shown in FIG. 15 may be an exposure apparatus other than the EUV exposure apparatus as long as it is an exposure apparatus capable of using the reflection type mask.

### Third Embodiment

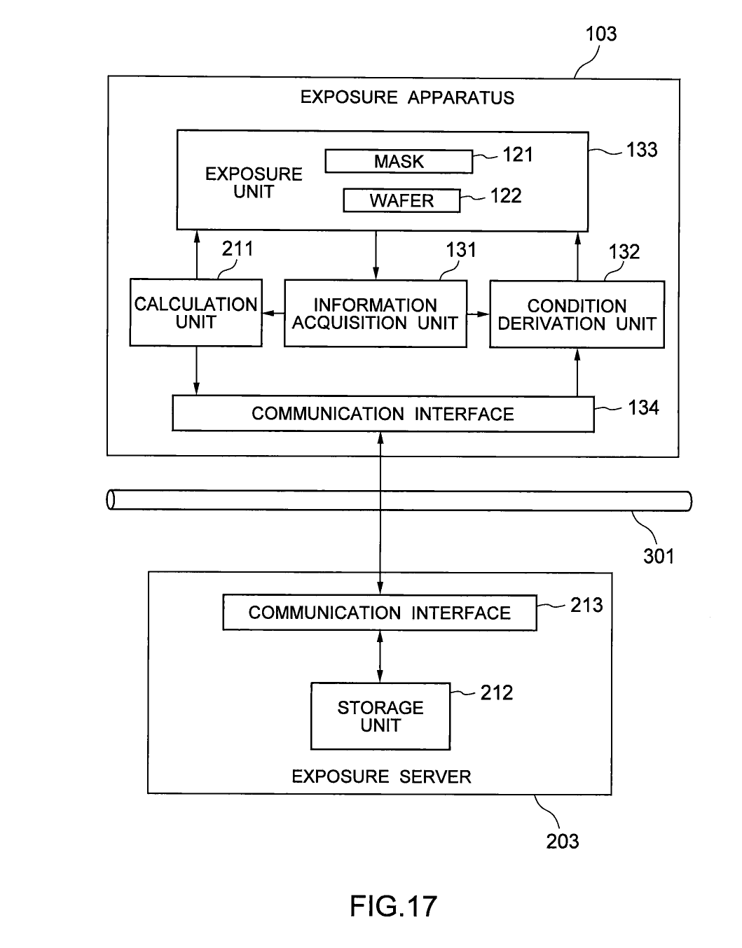

FIG. 17 is a block diagram showing configurations of an exposure apparatus 103 and an exposure server 203 of a third embodiment.

In FIG. 3, the calculation unit 211 is provided in the exposure server 201. On the other hand, in FIG. 17, the calculation unit 211 is provided in the exposure apparatus 103. In the present embodiment, the life of the mask 121 can be prolonged by adjusting the optical setting condition of the exposure apparatus 103 according to the use history of the mask 121, similarly to the first embodiment.

According to the present embodiment, it becomes possible to prolong the life of the mask 121, similarly to the first embodiment. In the present embodiment, the information processing function is not required in the exposure server 203. Therefore, there is an advantage in the present embodiment that an apparatus which does not have a sophisticated information processing function, such as a storage server or the like, can be adopted as the exposure server 203. On the other hand, since in the first embodiment, the calculation unit 211 is provided in the exposure server 201, there is an advantage that it becomes unnecessary to provide the calculation unit 211 in each of the plurality of exposure apparatuses 101.

### Fourth Embodiment

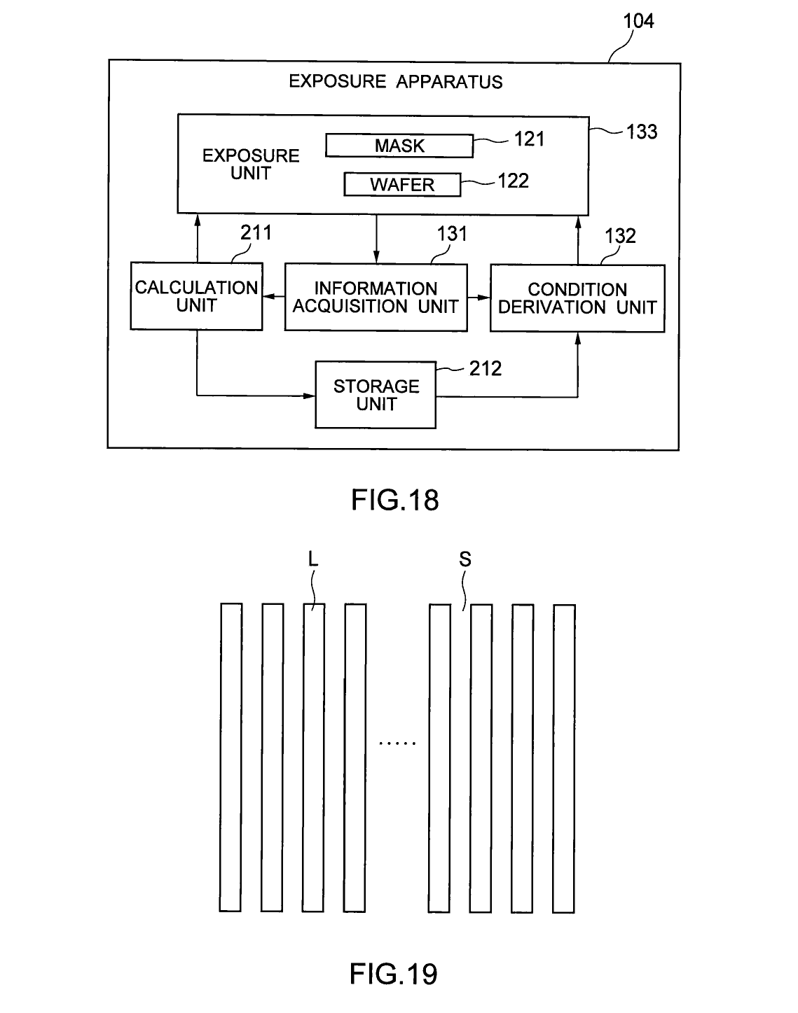

FIG. 18 is a block diagram showing a configuration of an exposure apparatus 104 of a fourth embodiment.

In FIG. 18, all of the information acquisition unit 131, the condition derivation unit 132, the exposure unit 133, the calculation unit 211, and the storage unit 212 are provided in the exposure apparatus 104. In other words, in the present embodiment, the exposure system shown in FIG. 1 is formed of only one exposure apparatus 104. In the present embodiment, the life of the mask 121 can be prolonged by adjusting the optical setting condition of the exposure apparatus 104 according to the use history of the mask 121, similarly to the first embodiment.

According to the present embodiment, it becomes possible to prolong the life of the mask 121, similarly to the first embodiment as described heretofore. The present embodiment has an advantage that the flows shown in FIGS. 13 and 14 can be executed by using only one exposure apparatus 104.

In the present embodiment, it is also possible to prepare a plurality of exposure apparatuses, each of which is the same as the exposure apparatus 104 shown in FIG. 18, and to connect these exposure apparatuses via a network. This has an advantage that it becomes possible for the plurality of exposure apparatuses to share the correspondence information collected by one exposure apparatus without the exposure server.

As described above, according to the first to fourth embodiments, it becomes possible to prolong the life of the mask by adjusting the optical setting condition of the exposure apparatus. The exposure processing in these embodiments is effective, for example, when manufacturing a semiconductor device having a memory circuit. The reason is that the mask pattern of the mask for the memory circuit is comparatively simple in many cases and consequently, it is comparatively easy to compensate the mask degradation by adjusting the optical setting condition.

FIG. 19 is a top view showing an example of the resist pattern formed on the wafer. The resist pattern shown in FIG. 19 corresponds to an L/S (Line and Space) pattern for forming the memory circuit. In FIG. 19, line parts are denoted by L and space parts are denoted by S.

The mask pattern of the mask for the L/S pattern is very simple as appreciated from FIG. 19. Therefore, the exposure processing in the first to fourth embodiments is effective especially for such a mask.

As described above, the embodiments described herein can provide an exposure apparatus, an exposure system, and a method of manufacturing a semiconductor device which are capable of prolonging the life of the photomask.

While certain embodiments have been described, these embodiments have been presented by way of example only, and are not intended to limit the scope of the inventions. Indeed, the novel apparatuses, systems and methods described herein may be embodied in a variety of other forms; furthermore, various omissions, substitutions and changes in the form of the apparatuses, systems and methods described herein may be made without departing from the sprit of the inventions. The accompanying claims and their equivalents are intended to cover such forms or modifications as would fall within the scope and sprit of the inventions.

1. An exposure apparatus configured to irradiate a mask with illumination light and to irradiate a wafer with light from the mask irradiated with the illumination light, the apparatus comprising:
an information acquisition unit configured to acquire use history information that is information regarding a use history of the mask;
a condition derivation unit configured to derive a setting value or a change amount of an optical setting condition of the exposure apparatus, based on the acquired use history information and correspondence information that indicates a correspondence between the use history of the mask and the optical setting condition of the exposure apparatus; and
an exposure unit configured to set the optical setting condition of the exposure apparatus to an optical setting condition specified by the derived setting value or change amount, and to expose the wafer under the set optical setting condition.

2. The apparatus according to claim 1, wherein
the use history information is a light irradiation amount to the mask, a number of wafers processed by using the mask, or light irradiation time to the mask.

3. The apparatus according to claim 1, wherein
the optical setting condition is a luminance distribution, a wavelength distribution, a shape, or a polarization state of the illumination light, a numerical aperture or an aberration of a projection lens for irradiating the wafer with the light from the mask, or an inclination amount of a principal surface of the wafer from an image forming plane.

4. The apparatus according to claim 1, wherein
the correspondence information is collected information by conducting exposure processing by using another mask having the same structure as the mask.

5. The apparatus according to claim 1, wherein
the correspondence information is a function or a table indicating a correspondence between the use history and the optical setting condition.

6. The apparatus according to claim 1, wherein
the correspondence information indicates an optical setting condition which keeps a contrast of an obtained image constant even if the use history of the mask changes.

7. The apparatus according to claim 1, wherein
the condition derivation unit reads out the correspondence information from an exposure server storing the correspondence information.

8. The apparatus according to claim 1, further comprising a storage unit to store the correspondence information,
wherein the condition derivation unit reads out the correspondence information from the storage unit.

9. The apparatus according to claim 8, further comprising:
a calculation unit configured to calculate the setting value or the change amount of the optical setting condition, and to store the correspondence between the use history and the calculated optical setting condition in the storage unit.

10. The apparatus according to claim 1, wherein
the illumination light is emitted from an illumination unit having a pole in a first direction and a pole in a second direction which is different from the first direction, and
the exposure unit changes the optical setting condition by changing a balance between a luminance of the pole in the first direction and a luminance of the pole in the second direction.

11. The apparatus according to claim 1, wherein
the mask is configured to be used for forming an L/S (Line and Space) pattern for a memory circuit on the wafer.

12. The apparatus according to claim 1, wherein the mask is of a transmission type or a reflection type.

13. The apparatus according to claim 1, wherein the exposure apparatus is an ArF (argon fluoride) exposure apparatus or an EUV (Extreme Ultra Violet) exposure apparatus.

14. An exposure system comprising an exposure apparatus configured to irradiate a mask with illumination light and to irradiate a wafer with light from the mask irradiated with the illumination light, and an exposure server configured to function as a server for the exposure apparatus, the apparatus comprising:
an information acquisition unit configured to acquire use history information that is information regarding a use history of the mask;
a condition derivation unit configured to derive a setting value or a change amount of an optical setting condition of the exposure apparatus, based on the acquired use history information and correspondence information that indicates a correspondence between the use history of the mask and the optical setting condition of the exposure apparatus and is stored in the exposure server; and
an exposure unit configured to set the optical setting condition of the exposure apparatus to an optical setting condition specified by the derived setting value or change amount, and to expose the wafer under the set optical setting condition.

15. The system according to claim 14, the exposure server comprising:
a calculation unit configured to calculate the setting value or the change amount of the optical setting condition, and to store the correspondence between the use history and the calculated optical setting condition in the exposure server.

16. The system according to claim 14, the exposure apparatus further comprising:
a calculation unit configured to calculate the setting value or the change amount of the optical setting condition, and to store the correspondence between the use history and the calculated optical setting condition in the exposure server.

17. The system according to claim 14, comprising a plurality of exposure apparatuses, and the exposure server configured to function as the server for the plurality of exposure apparatuses.

18. A method of manufacturing a semiconductor device by using an exposure apparatus configured to irradiate a mask with illumination light and to irradiate a wafer with light from the mask irradiated with the illumination light, the method comprising:
acquiring use history information that is information regarding a use history of the mask;
deriving a setting value or a change amount of an optical setting condition of the exposure apparatus, based on the acquired use history information and correspondence information that indicates a correspondence between the use history of the mask and the optical setting condition of the exposure apparatus; and
setting the optical setting condition of the exposure apparatus to an optical setting condition specified by the derived setting value or change amount, and exposing the wafer under the set optical setting condition.

19. The method according to claim 18, wherein
the correspondence information is read out from a exposure server storing the correspondence information.

20. The method according to claim 18, wherein
the correspondence information is previously stored in a storage unit in the exposure apparatus, and is read out from the storage unit.
